(19) United States
(12) Patent Application Publication
(10) Pub. No.: US 2021/0192909 A1
(43) Pub. Date: Jun. 24, 2021

(54) ON-CAMERA TAMPER DETECTION

(71) Applicant: Honeywell International Inc., Morris Plains, NJ (US)

(72) Inventors: Mark Openshaw, Oswestry (GB); Vijay Dhamija, Cummings, GA (US); Lalitha M. Eswara, Bangalore (IN); Jeremy Kimber, Lymm (GB)

(21) Appl. No.: 16/723,837

(22) Filed: Dec. 20, 2019

(51) Int. Cl. G08B 13/196; H04N 5/225; H04N 7/18

(52) U.S. Cl. CPC G08B 13/19697; G08B 13/19619; H04N 7/18; H04N 5/2252

(57) ABSTRACT

Methods and systems for detecting tampering with or to a video camera that are performed at the video camera. An illustrative video camera for use in a security system may include a housing for housing an image sensor, a lens for directing incoming light towards the image sensor, a plurality of tamper detection sensors each providing a sensed value, a controller, and a memory operatively coupled to the controller. The memory may store a set of normal sensor values for the plurality of tamper detection sensors. The controller may be configured to repeatedly poll each of the plurality of tamper detection sensors to receive a set of current sensor values and to compare the set of current sensor values with the set of stored normal sensor values. The controller may be configured to issue an alert when the identified one or more differences meets one or more predetermined criteria.

### TECHNICAL FIELD

The present disclosure relates generally to a video camera for use in a security system. More particularly, the present disclosure relates to methods and systems for detecting tampering with a video camera.

### BACKGROUND

Camera tamper detection is recognized as an important requirement in video surveillance. Camera tampering may include, but is not limited to: a camera being physically moved or hit, power disruption, vandalism, covering of the lens, blocking the view, blurring the image, focusing a bright light on the lens, changing the field of view, etc. In some cases, camera tampering may be detected by processing the video stream captured by the camera. However, this may be a software based solution which, when centralized at a server, can become complex due to repeated polling of cameras. When the software solution is applied at the camera itself, the camera may require higher-end processing elements, which may be cost prohibitive for many applications. What would be desirable is a lower cost solution for detecting camera tampering.

### SUMMARY

The present disclosure relates generally to a video camera for use in a security system. More particularly, the present disclosure relates to methods and systems for tamper detection with respect to a video camera.

In one example, a video camera for use in a security system may include a housing for housing a plurality of components including an image sensor, a lens for directing incoming light towards the image sensor, a plurality of tamper detection sensors each providing a sensed value, a controller operatively coupled to the image sensor and the plurality of tamper detection sensors, and a memory operatively coupled to the controller. The memory may store a set of normal sensor values for the plurality of tamper detection sensors. At least one of the normal sensor values for at least one of the tamper detection sensors may include a normal sensor pattern over time. For example, if a light that is in the field of view the camera it normally turned on each weekday at 7:00 AM, the normal sensor values for an ambient light sensor of the video camera may reflect that “normal” light pattern. The controller may be configured to repeatedly poll each of the plurality of tamper detection sensors to receive a set of current sensor values, and to compare the set of current sensor values with the set of stored normal sensor values and identify one or more differences. The controller may be configured to issue an alert when the identified one or more differences meets one or more predetermined criteria.

In some cases, the one or more predetermined criteria may include the one or more differences exceeding a threshold difference in response to each of least “N” polls of the plurality of tamper detection sensors within a predetermined amount of time, wherein “N” is an integer greater than 1.

In some cases, the normal sensor pattern over time may include an expected change in environmental conditions in or around the video camera. In some cases, the normal sensor pattern over time may be established during a training phase. In some cases, the training phase may occur over one or more period of times representative of one or more different operating conditions.

In another example, a video camera for use in a security system may include a housing for housing a plurality of components including an image sensor, a lens for directing incoming light towards the image sensor, one or more structural tamper detection sensors for detecting a structural tampering of the video camera, each of the one or more structural tamper detection sensors providing a sensed value, one or more functional tamper detection sensors for detecting a functional tampering of the video camera, each of the one or more functional tamper detection sensors providing a sensed value, a controller operatively coupled to the image sensor, the one or more structural tamper detection sensors and the one or more functional tamper detection sensors, and a memory operatively coupled to the controller. The memory may store a set of normal sensor values for the one or more structural tamper detection sensors and the one or more functional tamper detection sensors, wherein at least one of the normal sensor values for at least one of the functional tamper detection sensors includes a normal sensor pattern over time. The controller may be configured to repeatedly poll each of the one or more structural tamper detection sensors and each the one or more functional tamper detection sensors to receive a set of current sensor values and/or patterns, and to compare the set of current sensor values with the set of stored normal sensor values and/or patterns and identify one or more differences. The controller may be configured to issue an alert when the identified one or more differences meets one or more predetermined criteria.

In some cases, the set of normal sensor values for the one or more structural tamper detection sensors and the one or more functional tamper detection sensors may be expressed in a normal vector, and wherein the set of current sensor values of the one or more structural tamper detection sensors and the one or more functional tamper detection sensors are expressed in a sensed vector, and wherein comparing the set of current sensor values with the set of stored normal sensor values includes comparing the normal vector and the sensed vector.

In some cases, the one or more structural tamper detection sensors may include an electrical contact that, when the video camera is assembled, completes an electrical circuit that is monitored by the controller, and when the video camera is disassembled by tampering, the electrical contact becomes disengaged thereby breaking the electrical circuit which is detected by the controller.

In some cases, the one or more functional tamper detection sensors may include one or more of an ambient light sensor, a vibration sensor, an accelerometer, a digital compass, and a touch sensor.

In some cases, the one or more predetermined criteria may include the one or more differences exceeding a threshold difference in response to each of least “N” polls of the one or more structural tamper detection sensors and the one or more functional tamper detection sensors within a predetermined amount of time, wherein “N” is an integer greater than 1.

In another example, a video camera for use in a security system may include a housing, an image sensor housed by the housing, a lens housed by the housing for directing incoming light towards the image sensor, a controller housed by the housing, the controller operatively coupled to the image sensor, one or more connectors housed by the housing and operatively coupled to the controller, the one or more connectors accessible from outside of the housing and configured to selectively connect to one or more cables of a security system, and a sensor operatively connected to the controller, the sensor configured to sense a force applied to one or more of the connectors. The controller may be configured to issue an alert when the sensor senses a force applied to one or more of the connectors that meets one or more predetermined criteria.

In some cases, the sensor may include a pressure sensor. In some cases, the sensor may include a force sensor. In some cases, the one or more predetermined criteria may include the sensed force exceeding a predetermined threshold. In some cases, the one or more predetermined criteria may include the sensed force changing by more than a predetermined threshold. In some cases, the one or more predetermined criteria may include the sensed force changing in accordance with a predetermined force profile.

In some cases, the video camera may further include one or more electrical contacts that, when the video camera is assembled, complete an electrical circuit that is monitored by the controller, wherein at least one of the one or more electrical contacts become disengaged when the video camera is disassembled, thereby breaking the electrical circuit, wherein the controller is configured to issue an alert when the electrical circuit is broken. In some cases, one or more of the electrical contacts may include a screw that must be removed to disassemble the video camera, wherein when the screw is removed, the corresponding electrical contact becomes disengaged thereby breaking the electrical circuit.

In some cases, the video camera may further include one or more additional sensors configured to detect unauthorized tampering of the video camera. In some cases, the one or more additional sensors may include an ambient light sensor, a vibration sensor, an accelerometer, a digital compass, a touch sensor and/or combinations thereof.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic diagram of an illustrative video camera for use in a security system;

FIG. 2 is a schematic diagram of the illustrative video camera of FIG. 1 including a plurality of tamper detection sensors;

FIG. 3 is a flow diagram of an illustrative method of tamper detection;

FIG. 4 is a flow diagram of an illustrative method for establishing normal patterns;

FIG. 5 is a flow diagram of an illustrative method of tamper detection; and

FIG. 6 is an illustrative block diagram of a sensor pattern.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

The present disclosure relates generally to a video camera for use in a security system or video surveillance system. As described above, there is a need for having a lower cost solution that may not need high end processing of video streams at the edge or have the challenges of processing video streams on a central server. Generally, with this system, sensors and hardware provide an on-board solution for camera tampering. It is contemplated that both structural and functional integrity of the camera may be monitored using specific sensors for analysis. Some illustrative sensors that may be used for camera tampering detection include, for example, ambient light sensors, accelerometers, gyroscopes, vibration sensors, force sensors, pressure sensors, digital compasses, among others. These sensors may be mounted on the camera, within the camera housing, or to other components of the camera. It is contemplated the alignment mechanism of the camera may also be used to detect hit or breakage. In some cases, simple analytics of the sensor values may be used for detecting tampering while avoiding false alarms. In some cases, some of the same sensors, such as an accelerometer, gyroscope and/or vibration sensor, may be used to determine a parameter that relates to wear and tear on the camera.

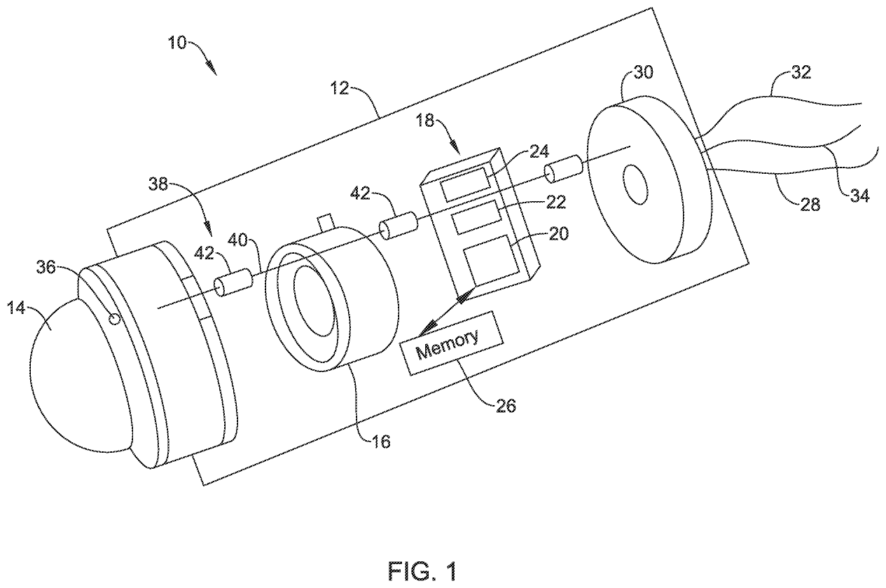

Camera tampering can affect both the structure of the camera and functionality of the camera. This camera tamper detection system may specify different sensors and mechanisms for detecting both of these conditions. FIG. 1 illustrates a schematic diagram of an illustrative video camera 10 for use in an alarm and/or surveillance system. The video camera 10 of FIG. 1 does not include all structural and/or functional elements of a video camera, but for clarity, just some of the elements are shown. The illustrative video camera 10 may include a housing 12 for enclosing the components of the video camera 10. In some cases, the video camera 10 may be a dome camera including a transparent protective dome 14. However, this is not required. In some cases, the video camera 10 may be bullet camera. The video camera 10 may have a fixed field of view or may be a pan-tilt-zoom (PTZ) camera, as desired. It is contemplated that the video camera 10 may be for indoor and/or outdoor use and for day and/or night use, as desired. In some cases, the housing 12 may be weatherproof for use outside or one or more night vision light emitting diodes (LED) may be provided adjacent to the dome 14 for night use.

Within the housing 12, the illustrative video camera 10 may include or house a lens 16. The lens 16 may be configured to direct incoming light towards an image sensor 22. The image sensor 22 may process the light captured by the lens 16 into a digital signal. The digital signal (e.g., the video recording) may be stored in a memory 26 of the video camera 10. In some cases, the image sensor 22 may be provided as a part of a control printed circuit board 18, although this is not required. The control printed circuit board 18 may include a processor or controller 20. While some components are described as being a part of the control printed circuit board 18, these components may be provided separate from control printed circuit board 18. In some cases, the controller 20 may be configured to poll various sensors for data, analyze the sensor data, and determine when the video camera 10 has been tampered with. The controller 20 may also be in communication with, or operatively coupled to the memory 26. The memory 26 may be used to store any desired information, such as, but not limited to, machine instructions for how to process data from the sensors and/or digital signals from the image sensor. The memory 26 may be any suitable type of storage device including, but not limited to, RAM, ROM, EPROM, flash memory, a hard drive, and/or the like. In some cases, the controller 20 and/or image sensor 22 may store information within the memory 26, and may subsequently retrieve the stored information from the memory 26.

In some embodiments, the video camera 10 may be equipped with a communications module 24. The communications module 24 may allow the video camera to communicate with other components of the security system, such as, but not limited to a network video recorder (NVR) and/or a remote monitoring station. The communications module 24 may provide wired and/or wireless communication. In one example, the communications module 24 may be use any desired wireless communication protocol such as but not limited to cellular communication, ZigBee, REDLINK™, Bluetooth, WiFi, IrDA, dedicated short range communication (DSRC), EnOcean, and/or any other suitable common or proprietary wireless protocol, as desired. In another example, the communications module 24 may communicate over a network cable 28. In some cases, the network cable 28 may be a power over Ethernet (POE) cable. The illustrative video camera 10 may receive power over a POE cable, a separate power cable 32, a battery, or any other suitable power source, as desired.

The illustrative video camera 10 may further include a back box 30. The back box 30 may be mounted to the housing 12 to mount the video camera 10 to a wall or ceiling. In some cases, the back box 30 may be coupled to an exterior of the housing 12 while in other cases, the back box 30 may be within or interior to the housing 12. In some cases, the back box 30 may house cable connections. For example, the back box 30 may house a connection between, for example: a network cable 28 and the control printed circuit board 18, a connection between a power cable 32 and the control printed circuit board 18, and/or an audio cable 34 and the control printed circuit board 18. It is contemplated that the video camera 10 may include other cables and/or connections, as desired. In some cases, the connection between the video camera 10 and the network may be tested using the internal circuitry of the connection ports within the back box 30. The ports may include LEDS which glow a certain color to indicate connectivity.

In some embodiments, the video camera 10 may include an alignment mechanism 38 which may be a structural tamper sensor configured to detect structural tampering with the video camera 10. The alignment mechanism 38 may include a plurality of interconnected wires or tubes 40 and screws 42 (or other fixing mechanisms) configured to maintain a desired orientation between the dome 14, the lens 16, the control printed circuit board 18 and/or the back box 30. The alignment mechanism 38 may extend from the dome 14 (or a first end of the housing 12) to the back box 30 (or a second end of the housing 12), and may form a circuit. The alignment mechanism 38 may be connected to the control printed circuit board 18, and micro switches (not explicitly shown) may indicate breakage or damage of any portion of the alignment mechanism 38 circuit. If the circuit is broken due to any mechanical impact or disassembly of the video camera 10, the switch may indicate a disconnection in the circuitry and may raise an alert signal. The alert may be captured by the controller 20 and sent to a user. More generally, the alignment mechanism 38 may complete an electrical circuit that is monitored by the controller 20, and when the video camera is disassembled by tampering or structurally damaged, the electrical circuit may be broken which is detected by the controller 20. In some cases, at least a portion of the electrical circuit may include a mounting element that must be removed to disassemble the video camera 10. Thus, removal of the mounting screw may cause the electrical circuit to become broken, and an alarm to be initiated.

While the video camera 10 is described as a video camera that provides a video stream, in some cases the video camera 10 may be a still camera that captures still images, perhaps on a particular schedule or in response to detected motion. In either case, the images or video streams captured by the video camera 10 may be transmitted to a server. In some cases, the server may provide live video streams to a workstation or other remote device, and may store or archive some or all of the video streams for later review. The server may be a cloud server, but this is not necessary in all cases. The server may represent a single computer, or the server may represent a large number of computers that are networked together. The video camera 10 may be hard wired to a device such as a computer, a router, a modem, or a gateway that itself communicates with the server. Alternatively, or additionally, the video camera 10 may communicate wirelessly with the server.

A workstation or remote device may be in communication with the server such that the images or video streams captured by the video camera 10 may be accessed and viewed on the workstation and/or remote device. In some instances, the workstation and/or remote device may be used to control the video camera 10, or to adjust the video camera 10. In some cases, the workstation and/or the remote device may, either separately or in combination, provide a way for an individual such as a security officer, to view footage captured by the video camera 10. In some cases, the video camera 10 may communicate with a remote monitoring station, which may be a server or any other suitable device.

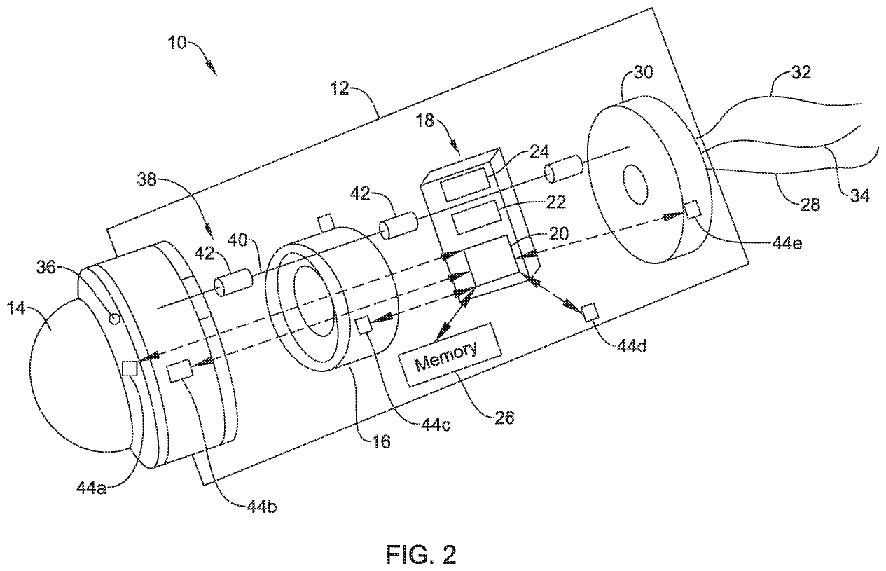

FIG. 2 is a schematic diagram of the illustrative video camera 10 of FIG. 1 with a plurality of functional tamper detection sensors 44a-e (collectively, 44) configured to detect interference with the functionality of the video camera 10. Each of the sensors 44 may be communicatively coupled with the controller 20 (e.g., wired or wireless communication). As will be described in more detail herein, the tamper detection sensors 44 may each provide a sensed value to the controller 20. A number of different types of tamper detection sensors are contemplated and described with respect to FIG. 2. It is contemplated that the video camera 10 may be provided with any combination (e.g., less than all) of the tamper detections sensors or all of the tamper detections sensors, as desired. The tamper detection sensors 44 may be small, low-cost, and require less processing power to identify tampering than video analytics. While the sensors 44 are described as tamper detection sensors, the sensors 44 may also be used to detect a measure of wear and tear on the video camera 10 in order to proactively predict necessary maintenance and/or replacement before the video camera 10 becomes non-functional.

A first tamper detection sensor may include an ambient light sensor 44a positioned on or adjacent to an exterior of the housing 12. In some cases, the ambient light sensor 44a may be positioned on or adjacent to the dome 14 (or other lens cover). The ambient light sensor 44a may detect an amount of ambient light in the room in which the video camera 10 is located or entering the video camera 10. It is contemplated that data or sensor values from the ambient light sensor 44a may be used to determine whether or not there are lights on in the room, if the video camera 10 view is blocked (through object placement or paint, for example), if a bright light is being shone into the lens 16, etc.

Another tamper detection sensor may include a vibration sensor 44b. The vibration sensor 44b may be configured to detect when an object contacts the video camera 10. For example, if an object is thrown at (or otherwise brought into contact with) the video camera 10 and makes contact with an area adjacent to the video camera 10 or the video camera 10 itself, the video camera 10 may shake or vibrate. This movement may be detected by the vibration sensor 44b. It is further contemplated that the vibration sensor 44b may alert a user to potential structural damage to the video camera 10. In some cases, the vibration sensor 44b may cooperate with the alignment mechanism 38 in determining structural damage. It is further contemplated that the vibration sensor 44b may provide data which is used to detect small and/or continuous vibrations caused by the environment that can impact the functionality off the video camera 10 through wear and tear.

Another tamper detection sensor may include an accelerometer (e.g. one-dimensional accelerometer or other accelerometer, as desired) 44c. The accelerometer 48 may be affixed on or adjacent to the lens 16. It is contemplated that during routine use, the lens 16 may be moved or adjusted to change a focal length of the image. However, in some cases, the lens 16 may be moved to intentionally blur the acquired image. It is contemplated that unexpected movement of the lens 16 may be detected by the accelerometer 44c. It is further contemplated that the accelerometer 44c may provide data which is used to detect the frequency and/or overall number of movements of the lens 16 that can impact the functionality off the video camera 10 through wear and tear.

Yet another tamper detection sensor may be a digital compass 44d. The digital compass 44d may be configured to detect camera movement and/or a change in camera field of view. For example, the digital compass 44d may be configured to differentiate between the current position of the video camera 10 and where the video camera 10 should be based on the control signals.

Another tamper detection sensor may be a force sensor, a touch sensor, or a pressure sensor 44e. The force sensor 44e may be coupled to or adjacent to the back box 30. The force sensor 44e may be configured to detect attempts to remove the video camera 10 from its mounting location. In some cases, the force sensor 44e may detect attempts to access the cables 28, 32, 34. For example, if a person were attempting to access to the network cable 28 in an attempt to access the building network through, for example, stripping the insulative coating off of network cable and biting or clamping a device onto the exposed wires (e.g., vampiring), the force sensor 44e may detect attempts to do so. Likewise, if a person were to detect removing the network capable from the cable connector on the back box 30, the force sensor 44e may detect attempts to do so. In some cases, the video camera 10 may include a battery that is only activated when the power supply cable 32 is tampered with or disconnected. It is further contemplated that in some cases, the communications module 24 may only communicate wirelessly when the network cable 28 is tampered with or disconnected (e.g. as identified by the force sensor 44e).

In some cases, the controller 20 may be configured to issue an alert when the sensor 44e senses a force applied to the back box 30 and/or one or more of the cables 28, 32, 34 that exceeds a predetermined criteria. For example, the controller 20 may issue an alert when the force measured at the sensor 44e changes by a more than a predetermined threshold or exceeds a predetermined threshold. It is contemplated that a baseline or normal force profile may be determined in a training phase.

While not explicitly shown, other tamper detection sensors 44 may be used, as desired. For example, in some cases, microphones, temperature sensors, occupancy sensors, motion sensors, etc., may be used as tamper detection sensors 44. This list is not meant to be inclusive of every sensor that may be used as a tamper detection sensor 44, but rather illustrative of some suitable sensors.

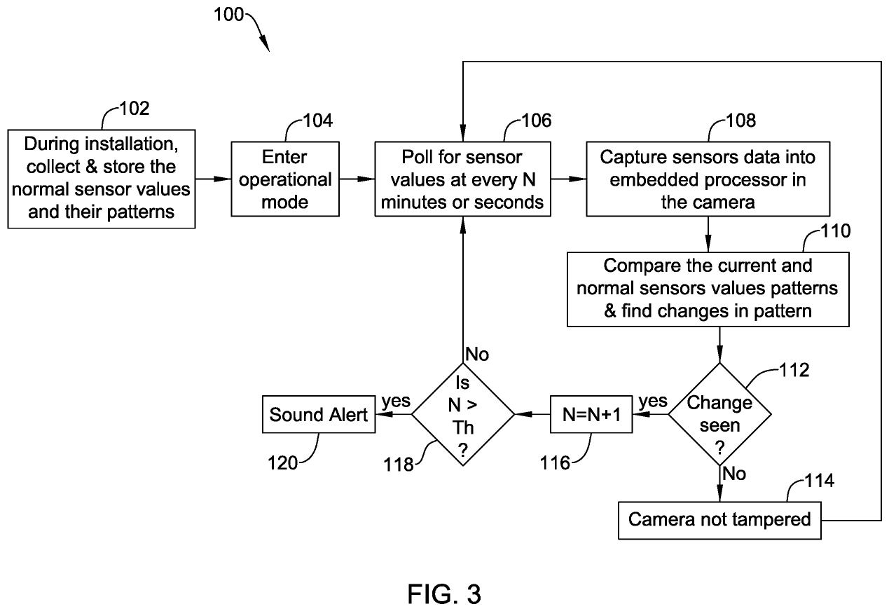

FIG. 3 a flow diagram of an illustrative method 100 of tamper detection. As described above, the video camera 10 may be mounted along with the included tamper detection sensors 44 and/or the alignment mechanism 38. During installation, or for a time period thereafter, data may be collected from the sensors 44 to establish normal sensor values and their patterns that are representative of one or more different operating conditions of the environment in which the video camera 10 is located, as shown at block 102. It is contemplated that the sensors 44 may be placed in a training mode for a period of time sufficient to establish normal values and/or patterns for a number of different expected conditions. The training mode can be repetitively entered before and/or after testing or operating periods. It is contemplated that the controller 20 may be programmed to automatically initiate training periods at predefined intervals (e.g., every so many hours, days, weeks, etc.). For example, if the video camera 10 is installed in a bank, the ambient light sensor 44 may be expected to sense a certain level of light during normal business hours and less or even no light after business hours, on weekends, and/or holidays. In another example, if a piece of equipment such as a fan, machine or other device in the environment causes a vibration of the video camera 10 with a certain frequency pattern and in some cases for a certain duration, the vibration sensor 44b may sense this vibration in the training mode and establish the particular vibration as a normal value and/or normal pattern. These are just examples.

It is contemplated that the video camera 10 may be placed into the training mode via a command issued through a remote device or via a training mode button or switch directly on the video camera 10, or other mechanism, as desired. It is contemplated that establishing normal sensor value patterns may help the controller 20 determine if, for example, a reduction in ambient light is due to a light being turned off or dimmed (e.g., expected or routine behavior) or by an object blocking the lens 16 (e.g., unexpected or tampering).

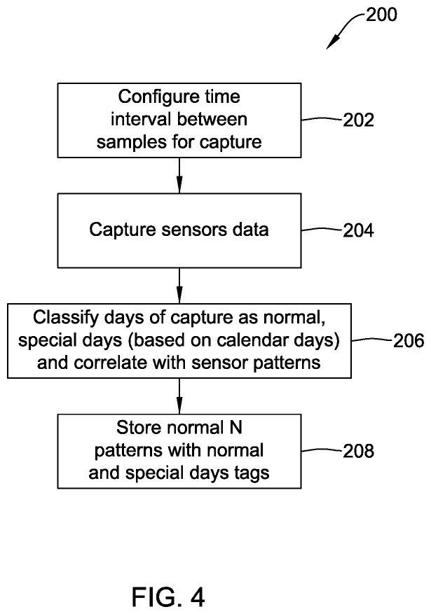

Referring additionally to FIG. 4, which illustrates a flow diagram of an illustrative method 200 for establishing normal patterns. The training mode may begin with a user configuring a time interval between data points (e.g., a sample acquisition rate), as shown at block 202. It is contemplated that the user may configure the sampling rate using a remote device (e.g., a PC, a laptop, tablet, smart phone, etc.) that is in communication with the controller 20 of the video camera 10 (e.g., via the communications module 24). The various sensors 44 may have the same data sampling rate or differing data sampling rates, as desired. For example, the data may be collected every millisecond, every second, every 5 seconds, every 15 seconds, every 30 seconds, every 1 minute, every 5 minutes, or any other suitable sample period. Once the sampling rates is configured, the controller 20 may begin to capture data from the sensors 44 by repeatedly polling the sensors 44 at the designated sampling rate, as shown at block 204. As the controller 20 captures the sensor data, the sensor data may be classified as normal or routine or as special days/times (e.g., nights, weekends, holidays, etc.), as shown at block 206. This classification may be stored with the sensor data in the memory 26, as shown at block 208. The sensor data may be stored as patterns with other relevant information as well, such as, but not limited to, the time the sensor data was collected, the day of the year (which can be correlated to local sunrise and sunset data), etc. In some cases, the normal sensor data patterns may be taken over a period of time so as to include an expected change in the environmental conditions in or around the video camera 10. It is further contemplated that the camera 10 can be placed into the training mode at predefined intervals, in response to frequently occurring false alarms, in response to repositioning of the camera 10, remodeling of the environment in which the camera 10 is placed, or other factors that may alter or change the normal sensor patterns.

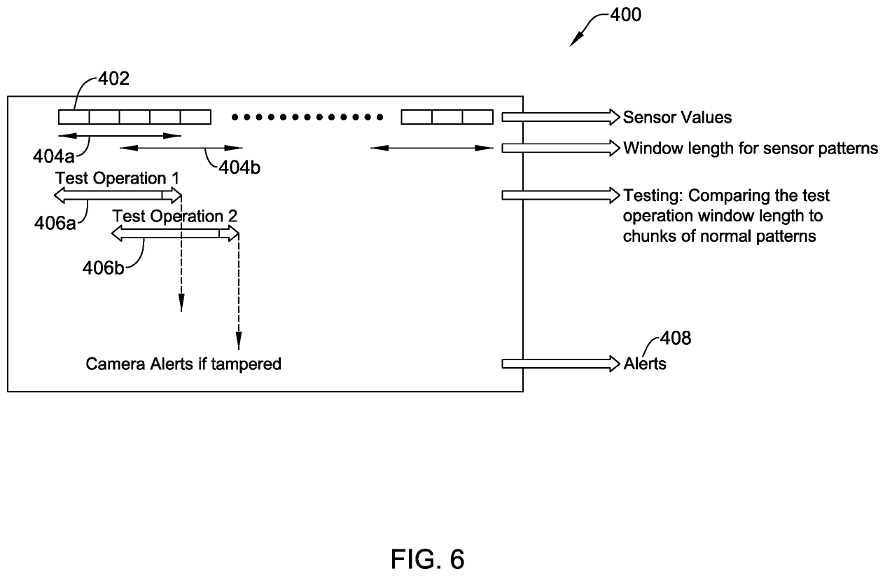

In some cases, data patterns may be sensor readings associated with a predetermined length of time or window, such as, for example, 5 seconds, 15 seconds, one minute, 5 minutes, 10 minutes, etc. As will be described in more detail herein with respect to FIG. 6, data patterns may overlap. For example, the beginning of one data pattern may occur halfway through a preceding data pattern, but this is not required. In some cases, the data from two or more sensors 44 may be combined into a vector representable of the state of the video camera 10 for a given time. For example, the controller 20 may be configured to take the data readings from a time point and make a vector that is representative of the video camera 10 at that given point in time. In some cases, successive vectors may be grouped into time windows (or periods of time) to form a pattern for comparison. Thus, the data pattern may be representative of a single sensor (e.g., a plurality of sensor values form the pattern) or a combination of sensors (e.g., a plurality of vectors form the pattern). For example, the set of normal sensor values for the structural tamper detection sensors 38 and/or the one or more functional tamper detection sensors may be expressed as a normal vector. It is contemplated that the video camera 10 may be placed into a training modes as needed to capture data for special days or as routines for normal day changes.

Returning to FIG. 3, once the normal patterns and vectors have been established (e.g., for normal and/or special days), the video camera 10 may be placed into an operational mode, as shown at block 104. The video camera 10 may be placed into the operational mode via a command issued through a remote device or via an operation mode button or switch directly on the video camera 10, or any other suitable mechanism, as desired.

Once in the operational mode, the sensors 44 may begin to collect data at predetermined intervals by repeatedly polling each of the sensors 44, as shown at block 106. The controller 20 may also verify the circuit of the alignment mechanism is still complete to verify the structural integrity of the video camera 10. It is contemplated that the predetermined time interval for the operational mode may be the same as the predetermined time interval (e.g., data sampling rate) for the training mode. The data is transmitted to the controller 20 as it is collected, as shown at block 108. The controller 20 may be configured to compare the current sensor values to the normal sensor values acquired during the training mode using a pattern change algorithm, as shown at block 110. In some cases, the controller 20 may be configured to group the current sensor values into patterns in a similar manner to those of the training mode. For example, data patterns may be sensor readings associated with a predetermined length of time, such as, for example, over 5 seconds, 15 seconds, one minute, 5 minutes, 10 minutes, etc. The controller 20 may be further configured to associate a time of day, a day of the week, a classification of the data as routine or special, etc. with the currently collected data. In some cases, the currently collected data from two or more sensors 44 may be combined into a vector representable of the state of the video camera 10 for a given time. For example, the controller 20 may be configured to take the data readings from a time point and make a vector that is representative of the video camera 10 at that given point in time. The set of current sensor values for the structural tamper detection sensors 38 and/or the one or more functional tamper detection sensors may be expressed as a sensed vector. In some cases, successive vectors may be grouped into time windows (or periods of time) to form a pattern for comparison.

The controller 20 may then identify if there are differences or changes between the current or operational sensor data and the normal sensor data, as also shown at block 110. In some cases, the controller 20 may compare a sensed vector with the previously acquired normal vector. The controller 20 may use any vector comparison method, such as, but not limited to, distance metrics that may include the Mahalanobis distance, Eucledian distance, etc. The controller 20 may then compare the current sensor data to normal sensor data that is of a same classification, same day of the week, same time of day, etc. to identify or determine if there is a change in the sensor values, pattern and/or vector, as shown at block 112. The controller 20 may determine that there is a difference if the distance metric (e.g., Mahalanobis, Eucledian, etc.) between the normal and the operation sensor vector is greater than a pre-determined value or range of values. If the controller 20 determines that there are no differences (e.g. less than a predetermined threshold difference), the controller 20 determines that the video camera 10 has not been tampered with, as shown at block 114. The process continues with the controller 20 continuing to poll the sensors 44 for data, as shown at block 106.

Returning to block 112, if the controller 20 determines that there is a difference (e.g. greater than the predetermined threshold difference), the controller 20 may determine if the differences meet one or more predetermined criteria. The one or more predetermined criteria may be the current sensor values exceeding the predetermined threshold difference in each of at least “N” polls of the plurality of tamper detection sensors within a predetermined amount of time, wherein “N” is an integer greater than 1. For example, if the controller 20 determines that there are differences (e.g. greater than the predetermined threshold difference), the controller 20 increases a counter of the number of times a difference has occurred, as shown at block 116. For example, when no differences (e.g. less than the predetermined threshold difference) have been identified, the counter with be at N=0. When a difference (e.g. greater than the predetermined threshold difference) has been identified, 1 will be added to the counter so N now equals 1 (e.g., 0+1). The counter may keep track of how many differences or changes have been identified over a predetermined length of time. The controller 20 may then compare the number of changes over the predetermined length of time (e.g., N) to a threshold number of changes (Th) (e.g., a predetermined minimum number of changes over predetermined length of time), as shown at block 118. The threshold number of changes may be determined by the user and any number desired, such as, but not limited to one, two, three, four or more. Similarly, the predetermined length of time over which the changes can occur may also be determined by the user.

If N is less than the threshold number of changes, the controller 20 determines that the video camera 10 has not been tampered with and the process continues with the controller 20 continuing to poll the sensors 44 for data, as shown at block 106. If N is greater than the threshold number of changes, the controller 20 may determine that the video camera 10 has been tampered with and an alert may be generated, as shown at block 120. While the method 100 references the sensors 44, it should be understood that the controller 20 may simultaneously determining if a break in the circuit of the alignment mechanism 38 has occurred. Anomalies in the alignment mechanism may be added to the change counter or tallied separately.

In some embodiments, generating an alert may send a notification to a remote device (e.g., a security monitoring station, a central server, a network video recorder, a mobile phone, etc.). Alternatively or additionally, the alert may be sent directly to a law enforcement agency. In some cases, the alert may be an audible (e.g., a siren or buzzer) or a visual alert (e.g., flashing lights) from the video camera 10 itself. It is contemplated that raising an alarm only when a threshold number of differences or changes occurs within a predetermined length of time may help prevent false alarms by not providing an alert when minor sensor variations (e.g., anomalies) and random changes affecting the sensor patterns are experienced.

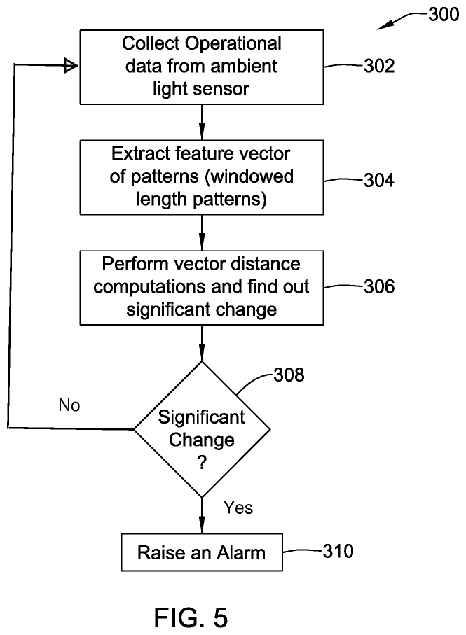

FIG. 5 is a flow chart of an illustrative method 300 of tamper detection with respect to a specific sensor. The method 300 is described with respect to a particular light sensor 44a, however, it should be understood that any sensor 44 or combination of sensors may be used. To being, the controller 20 may collect operational sensor data or values from, for example, a light sensor 44a, as shown at block 302. The sensor values may be collected at a predefined interval. As the sensor values are collected, the controller 20 may extract a pattern which corresponds to one or more values or vectors at one or more time points for a window of time (e.g., a predetermined length of time), as shown at block 304.

FIG. 6 shows a block diagram 400 of an illustrative sensor pattern and analysis. The individual sampled sensor values are represented at 402, where each square represents a sensor value at a corresponding sample time. These sensor values 402 may be individual values or converted into vectors. In the example shown, the sensors values 402 are grouped into a time window 404a, 404b (collectively, 404). In one illustrative embodiments, the first four sensor values 402a are grouped into a first window 404a. The second window 404b may also include 4 values and overlap the first window such that that third and fourth values are in both the first window 404a and the second window 404b. The windows 404 may include any number of sensor data points desired. The use of four data points is merely an example. It is contemplated that the overlapping the windows 404 may increase the robustness of the tamper detection system by providing a more accurate output and reducing inadvertent omissions of data points. However, it in some cases, the windows 404 may not overlap. As described herein, the pattern changes in each window 404 for successive windows or for a specified number of windows 404 within a specific time interval can be identified or flagged as a tampering. More than one such flag can confirm tampering and an alert generated.

Returning to FIG. 5, the controller 20 may then compare the operational pattern to a normal pattern of a same type of day and a similar time that was determined during a training phase, as shown at block 306. In some cases, the comparison may be performed using vector distance computations. Referring again to FIG. 6, the comparison operation may be performed between the operational window length 404a, 404b and a normal pattern time window 406a, 406b. The normal pattern time window 406a, 406b may have the same length of time, the same number of data points, gathered at a same (or similar) time of day, a same day of the week, and/or include a same type of day classification as the operational data 404a, 404b. The operational data that was gathered in the middle of a business day could be significantly different from normal operational data that was gathered in the middle of the night, and as such comparing these would likely result in false alerts.

It is further contemplated that the length of the window 404 may determine how quickly an alert may be generated. For example, if a time window corresponds to an hour, an hour or more may pass between a tampering event and an alert (especially if two or more significant changes are required for an alert to issue). Therefore, the time windows 404 may be configurable by an end user (e.g., via a remote device) for a particular environment in which the camera is placed.

Returning again to FIG. 5, the controller 20 may be configured to determine if there is a significant change in the operational data from the normal pattern, as shown at block 308. The controller 20 may determine that there is a significant change if the distance metric (e.g., Mahalanobis, Eucledian, etc.) between the normal and the operation sensor vector is greater than a pre-determined value or range of values. If there is no significant change, the controller 20 may return to block 302 and repeat the process. If there is a significant change, the controller 20 may determine if there have been more than a threshold number of successive significant changes (e.g., a significant change in each of a predetermined number of consecutive windows). If the number of successive significant changes exceeds a threshold, an alert may be sent, as shown at block 310 in FIG. 5 and arrow 408 in FIG. 6.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

1. A video camera for use in a security system, the video camera comprising:
a housing for housing a plurality of components including:
an image sensor;
a lens for directing incoming light towards the image sensor;
a plurality of tamper detection sensors each providing a sensed value;
a controller operatively coupled to the image sensor and the plurality of tamper detection sensors;
a memory operatively coupled to the controller, the memory storing a set of normal sensor values for the plurality of tamper detection sensors, wherein the normal sensor values for at least one of the tamper detection sensors form a normal sensor pattern over time correlated to a time of a day and/or a day of a year;
the controller is configured to repeatedly poll each of the plurality of tamper detection sensors to receive a set of current sensor values, and to compare the set of current sensor values with the set of stored normal sensor values, including the normal sensor values that form the normal sensor pattern over time correlated to the time of the day and/or the day of the year, and identify one or more differences; and
the controller is configured to issue an alert when the identified one or more differences meets one or more predetermined criteria.

2. The video camera for use in a security system of claim 1, wherein the normal sensor pattern over time is established during a training phase.

3. The video camera for use in a security system of claim 2, wherein the training phase occurs over one or more period of times representative of one or more different operating conditions.

4. The video camera for use in a security system of claim 1, wherein the one or more predetermined criteria comprise the one or more differences exceeding a threshold difference in response to each of least “N” polls of the plurality of tamper detection sensors within a predetermined amount of time, wherein “N” is an integer greater than 1.

5. The video camera for use in a security system of claim 1, wherein the normal sensor pattern over time includes an expected change in environmental conditions in or around the video camera.

6. A video camera for use in a security system, the video camera comprising:
a housing for housing a plurality of components including:
an image sensor;
a lens for directing incoming light towards the image sensor;
one or more structural tamper detection sensors for detecting a structural tampering of the video camera, each of the one or more structural tamper detection sensors providing a sensed value, wherein at least one of the structural tamper detection sensors is configured to detect wire tampering with one or more cables connected to the video camera;
one or more functional tamper detection sensors for detecting a functional tampering of the video camera, each of the one or more functional tamper detection sensors providing a sensed value;
a controller operatively coupled to the image sensor, the one or more structural tamper detection sensors and the one or more functional tamper detection sensors;
a memory operatively coupled to the controller, the memory storing a set of normal sensor values for the one or more structural tamper detection sensors and the one or more functional tamper detection sensors, wherein at least one of the normal sensor values for at least one of the functional tamper detection sensors comprises a normal sensor pattern over time;
the controller is configured to repeatedly poll each of the one or more structural tamper detection sensors and each the one or more functional tamper detection sensors to receive a set of current sensor values, and to compare the set of current sensor values with the set of stored normal sensor values and identify one or more differences; and
the controller is configured to issue an alert when the identified one or more differences meets one or more predetermined criteria.

7. The video camera of claim 6, wherein the set of normal sensor values for the one or more structural tamper detection sensors and the one or more functional tamper detection sensors are expressed in a normal vector, and wherein the set of current sensor values of the one or more structural tamper detection sensors and the one or more functional tamper detection sensors are expressed in a sensed vector, and wherein comparing the set of current sensor values with the set of stored normal sensor values comprises comparing the normal vector and the sensed vector.

8. The video camera of claim 6, wherein the one or more structural tamper detection sensors comprises an electrical contact that, when the video camera is assembled, completes an electrical circuit that is monitored by the controller, and when the video camera is disassembled by tampering, the electrical contact becomes disengaged thereby breaking the electrical circuit which is detected by the controller.

9. The video camera of claim 6, wherein the one or more functional tamper detection sensors comprises one or more of an ambient light sensor, a vibration sensor, an accelerometer, a digital compass, and a touch sensor.

10. The video camera of claim 6, wherein the one or more predetermined criteria comprise the one or more differences exceeding a threshold difference in response to each of least “N” polls of the one or more structural tamper detection sensors and the one or more functional tamper detection sensors within a predetermined amount of time, wherein “N” is an integer greater than 1.

11-20. (canceled)

21. A video camera for use in a security system, the video camera comprising:
a housing for housing a plurality of components including:
an image sensor;
a lens for directing incoming light towards the image sensor;
a plurality of tamper detection sensors each providing a sensed value over time;
a controller operatively coupled to the image sensor and the plurality of tamper detection sensors;
a memory operatively coupled to the controller, the memory storing a plurality of normal vectors over time each correlated to a time of a day and/or a day of a year, each of the plurality of normal vectors includes a plurality of normal sensor values each associated with a corresponding one of a predefined set of the plurality of tamper detection sensors;
the controller is configured to repeatedly poll each of the plurality of tamper detection sensors and to compare a current vector that corresponds to a current time of the day and/or a current day of the year and includes a plurality of current sensor values each associated with a corresponding one of the predefined set of the plurality of tamper detection sensors with the normal vector of the plurality of normal vectors that corresponds to the current time of the day and/or the current day of the year, and identify one or more differences; and
the controller is configured to issue an alert when the identified one or more differences meets one or more predetermined criteria.

22. The video camera for use in a security system of claim 21, wherein the plurality of normal vectors are established over time during a training phase.

23. The video camera for use in a security system of claim 22, wherein the training phase occurs over one or more period of times representative of one or more different operating conditions.

24. The video camera for use in a security system of claim 21, wherein the one or more predetermined criteria comprise the one or more differences exceeding a threshold difference in response to each of least “N” polls of the plurality of tamper detection sensors within a predetermined amount of time, wherein “N” is an integer greater than 1.
